(19) United States
(12) Patent Application Publication
(10) Pub. No.: US 2013/0087126 A1
(43) Pub. Date: Apr. 11, 2013

(54) ENRICHING AIR FOR AN ENGINE

(71) Applicant: George Lindsay Heeley, St Helens (GB)

(72) Inventor: George Lindsay Heeley, St Helens (GB)

(21) Appl. No.: 13/639,641

(22) PCT Filed: Apr. 6, 2011
(86) PCT No.: PCT/GB11/50683

§ 371 Date: Dec. 18, 2012

(30) Foreign Application Priority Data
Apr. 6, 2010 (GB) 1005713.1

(51) Int. Cl. F02M 25/00

(52) U.S. Cl. CPC F02M 25/00
USPC 123/559.1

(57) ABSTRACT

There is provided a method of enriching an air supply for an engine, said method comprising conveying pressurised air to a chamber containing a liquid and causing said air to pass through the liquid to enrich the air with one or more additives and then conveying enriched air from the chamber for supply to an engine. Also provided are an engine air supply assembly (1), apparatus (100) for enriching air and a vehicle incorporating the same.

### FIELD OF INVENTION

The present invention relates to enriching air for an engine, particularly, though not exclusively, to methods of enriching an air supply for an engine, to apparatus for enriching air for an engine, to engine air supply assemblies and to vehicles incorporating the aforesaid.

### BACKGROUND TO INVENTION

It is known that hydrocarbon fuel burning engines create CO₂ and other waste products that are believed to have a harmful effect on the environment. Various attempts have been made to improve the efficiency of engines or to treat exhaust gases to reduce their environmental impact. Many of these have however been complex solutions and have not necessarily been economically viable or practical.

Many vehicles are powered by diesel or petrol engines. Such engines typically have an air inlet manifold. Air from the manifold is delivered into a cylinder together with fuel where combustion of the mixture then takes place. A problem with such engines is that combustion is not always complete causing undesirable emissions and reducing fuel economy.

In vehicles driven by a petrol engine the engines typically have an air intake manifold which is at lower pressure to ambient air and which draws air in through an air filter to be mixed with petrol. The reduced pressure at the air intake manifold can be used to draw air through a chamber and enrich the air with volatile components from liquid held in the chamber.

Enriching the air supplied to the manifold of a diesel engine is however a harder problem to address. In vehicles driven by a diesel engine the engines typically have an air intake manifold which is at a higher pressure to ambient air. Accordingly, air can not be drawn through a chamber by virtue of their being a reduced air pressure at the inlet manifold.

Accordingly, the present invention aims to address at least one disadvantage associated with the prior art whether discussed herein or otherwise.

### SUMMARY OF INVENTION

According to a first aspect of the present invention there is provided a method of enriching an air supply for an engine, said method comprising conveying pressurised air to a chamber containing a liquid and causing said air to pass through the liquid to enrich the air with one or more additives and then conveying enriched air from the chamber for supply to an engine.

As used herein the term “pressurised air” means air which is at higher pressure than the ambient air.

Surprisingly, the present inventor has found that it is not necessary to use a reduced pressure air flow to allow an engine air supply to be enriched and he has instead found the inventive solution described herein.

Suitably, the method comprises conveying pressurised air into the chamber. Suitably, the method comprises causing pressurised air to pass through the liquid in the chamber. Suitably, the method comprises conveying pressurised enriched air from the chamber for supply to an engine.

Suitably, there is provided a method of enriching an air supply for an engine, said method comprising conveying pressurised air into a chamber containing a liquid and causing said pressurised air to pass through the liquid to enrich the air with one or more additives and then conveying pressurised and enriched air from the chamber for supply to an engine.

Suitably, the engine comprises a compression ignition engine. Suitably, the engine comprises a diesel engine.

Suitably the liquid comprises an oil based liquid. Suitably, the oil-based liquid is an upper cylinder lubricant.

Suitably, the chamber contains a liquid in such a quantity that an air space is provided above the liquid.

Suitably, the method comprises pressurising air. Suitably, the method comprises pressurising ambient air. Suitably, the method comprises pressurising air using pressurising means. Suitably, the pressurising means comprises a compressor, turbocharger or supercharger of an engine.

Suitably, there is provided a method of enriching an air supply for an engine, said method comprising pressurising air using a compressor, turbocharger or supercharger of an engine and conveying said air to a chamber containing an oil based liquid and causing said air to pass through the oil based liquid to enrich the air with one or more additives and then conveying enriched air from the chamber for supply to an engine.

Suitably, there is provided a method of enriching an air supply for an engine, said method comprising pressurising air using a compressor, turbocharger or supercharger of an engine and conveying said pressurised air into a chamber containing an oil based liquid and causing said pressurised air to pass through the oil based liquid to enrich the air with one or more additives and then conveying pressurised and enriched air from the chamber for supply to an engine.

Suitably, the method comprises drawing air into a pressurising means, pressurising said air and conveying a stream of air from the pressurising means to the chamber containing a liquid. Suitably, a first air stream is conveyed from the pressurising means to said chamber and a second air stream is conveyed to an engine, suitably to an air inlet manifold of an engine. Suitably, air which has passed through the chamber is combined with said second air stream and/or reintroduced to the pressurising means.

Suitably, the method comprises treating air before it is conveyed to the chamber. Suitably, the method comprises filtering air before it is conveyed to the chamber. Suitably, the method comprises filtering air before it enters the pressurising means. Suitably, the method comprises filtering air with a filter, suitably a multi-stage filter.

Suitably, the method comprises passing the air through a filter comprising copper, suitably copper mesh, suitably knitted copper mesh. Suitably, the method comprises passing air through a first filter stage comprising copper mesh and then through a second filter stage comprising copper mesh of smaller mesh size than the first. Suitably, the method comprises passing air through a third filter stage comprising copper mesh of smaller mesh size than the second.

Suitably, the method comprises passing an air stream through one or more valves before it enters the chamber to regulate the supply of air to the chamber. Suitably, the method comprises passing the first air stream through one or more valves to regulate the supply of air to the chamber. Suitably, the method comprises passing the air stream through a regulator valve. Suitably, the method comprises passing the air stream through an on/off valve. Suitably, the method comprises passing the air stream through a one way valve.

Suitably, the method comprises conveying pressurised air to the chamber via an air inlet. Suitably, the method comprises introducing pressurised air into the chamber via a submerged air inlet. Suitably, the method comprises introducing pressurised air into the chamber via an air inlet which lies towards the bottom of the chamber.

Suitably, the method comprises conveying enriched air from the chamber via an air outlet. Suitably, the method comprises removing enriched air from the chamber via a non-submerged air outlet. Suitably, the method comprises removing enriched air from the chamber via an air outlet which lies at or towards the top of the chamber.

Suitably, the chamber contains a liquid in such a quantity that an air space is provided above the liquid and the method comprises causing pressurised air to pass through the liquid to enrich the air and said enriched air, suitably pressurised enriched air, occupies said air space before being conveyed from the chamber.

Suitably, the chamber has a lower section which contains a liquid, suitably an oil based liquid and an upper section which comprises an air space. Suitably, a baffle means is located within the chamber to restrict the movement of liquid between the upper and lower sections whilst allowing the flow of air there between.

Suitably, the method comprises conveying air to the chamber via an entrance port which is located at the top of the chamber and which is in fluid communication with an inlet tube which extends downwardly in the chamber and provides an air inlet to the chamber towards the bottom of the chamber.

Suitably, the method comprises conveying pressurised air into the chamber such that air bubbles through the liquid. Suitably, the method comprises conveying air into the chamber such that air is introduced into liquid lying towards the bottom of the chamber.

Suitably, the method comprises causing pressurised air to pass through the liquid such that it is enriched as it passes through the liquid. Suitably, the pressurised enriched air then travels passed the baffle means such that liquid from the chamber is substantially prevented from exiting the chamber whilst pressurised enriched air is allowed to exit.

Suitably, the air stream which exits the chamber is returned to a pressurising means. The majority of the enriched air may then be supplied to an engine whilst a portion may be re-circulated to the chamber. The air stream which exits the chamber may be returned directly to the pressurising means or returned indirectly by combining it with an air stream upstream of the pressurising means. Alternatively, or in addition, the air stream which exits the chamber may be combined with an air stream for supply to an engine at a point downstream of the pressurising means.

Suitably, the air stream which exits the chamber is returned to a pressurising means such that it is combined with and mixed with un-enriched air before being supplied to an engine air inlet manifold.

Suitably, the method comprises passing the air stream which exits the chamber through one or more valves to regulate the supply of air from the chamber. Suitably, the method comprises passing the air stream through a regulator valve.

Suitably, the method comprises passing the air stream which exits the chamber through a jet.

Suitably, the method comprises combining enriched air with un-enriched air at or upstream of an engine air intake manifold.

Suitably, the method comprises enriching air so as to provide improved combustion of fuel that the air is mixed with.

Suitably, the method comprises enriching air with cylinder lubricant, suitably an upper cylinder lubricant.

The method may comprise mixing enriched air with fuel, suitably diesel, for combustion.

The method may comprise passing pressurised enriched air through an intercooler before it is supplied to an engine.

Suitably, the method comprises enriching the air supply for an engine by incorporating combustible additives therein.

The method may further comprise adapting the operation of an engine. The method may comprises adapting the operation of an engine to take into account the supply of enriched air thereto. The method may comprise adapting the operation of an engine to take into account the fact the air supply comprises combustible additives. The method may comprise modifying the engine control electronics.

Suitably, the method comprises reducing the quantity of fuel supplied to the engine when the engine is supplied with enriched air compared to the quantity of fuel that would be supplied to the engine if supplied with un-enriched air. The method may comprise adapting the operation of an engine to take into account the supply of enriched air thereto by reducing the quantity of fuel supplied to the engine.

Suitably, the method comprises monitoring the amount of air being supplied to an engine and adjusting the fuel supply to the engine relative to the air supply. Suitably, the method comprises monitoring the amount of air passing through the engine air inlet manifold. Suitably, the method uses an airflow sensor, suitably located in the engine air inlet manifold.

Suitably, the method comprises monitoring the airflow through the engine air inlet manifold and controlling the supply of fuel to the engine in response thereto. Suitably, the method comprises monitoring the airflow using a sensor and modifying the sensor output and/or the response to the sensed airflow to compensate for the fact the air is enriched. The method may comprise wiring into an airflow sensor designed to operate with un-enriched air and adjusting the signal it produces such that fuel is supplied to the engine at an appropriate rate to accommodate the fact the air is enriched. The method may comprise adjusting the voltage and/or frequency of a sensor output.

Suitably, the method comprises reducing the rate of fuel supply to the engine for any given rate of enriched air supplied to the engine when compared to the rate at which fuel would be supplied to the engine if supplied with un-enriched air. The method may comprise adapting the operation of an engine to take into account the supply of enriched air thereto by reducing the rate at which fuel is supplied to the engine.

The method may comprise any feature as described in relation to the second aspect. Suitably, the method uses an apparatus according to the second aspect.

The method may comprise any feature as described in relation to the third aspect. Suitably, the method uses an engine air supply assembly according to the third aspect.

The method may comprise any feature as described in relation to the fourth aspect. Suitably, the method is performed in a vehicle according to the fourth aspect.

According to a second aspect of the present invention there is provided an apparatus for enriching air for an engine, said apparatus comprising:

(a) a chamber adapted to contain a liquid and to comprise an air space above said liquid;
(b) air inlet means adapted to convey pressurised air into the chamber such that it passes through said liquid;
(c) air outlet means adapted to convey enriched air from the chamber for supply to an engine; and
(d) baffle means adapted to restrict the egress of liquid from the chamber via the air outlet whilst allowing the passage of enriched air.

Suitably, the air outlet means (c) is adapted to convey pressurised enriched air from the chamber for supply to an engine.

Suitably, the baffle means (d) is adapted to restrict the egress of liquid from the chamber via the air outlet whilst allowing the passage of pressurised enriched air.

Suitably, the baffle means is located between said air inlet and air outlet and being adapted to restrict the egress of liquid from the chamber via the air outlet whilst allowing the passage of pressurised enriched air.

Suitably, the chamber is adapted to contain an oil based liquid. Suitably the oil-based liquid comprises a cylinder lubricant. Suitably, the oil-based liquid is an upper cylinder lubricant. Suitably, the chamber comprises a substantially enclosed chamber.

Suitably, the apparatus is adapted to receive pressurised air from a pressurising means such as a compressor, turbocharger or supercharger of an engine. Suitably, the apparatus is adapted to form part of an engine air supply assembly comprising a pressurising means.

Suitably, the air inlet means comprises an air inlet to the chamber which is adapted to be submerged by the liquid in use such that pressurised air is conveyed into the chamber such that it passes through said liquid.

Suitably, the air outlet means comprises an air outlet from the chamber which is adapted to be located within the air space in use and to convey pressurised enriched air from the chamber for supply to an engine.

Suitably, the apparatus is adapted to supply enriched air, which is suitably pressurised enriched air, such that it is reintroduced to a pressurising means from which it is supplied to an engine and/or such that it is combined with an air stream from a pressurising means downstream thereof such that the combined air stream is supplied to an engine.

Suitably, the apparatus is adapted such that enriched air is reintroduced to a pressurising means directly and/or is reintroduced indirectly by combining it with a an air stream up stream of the pressurising means. Suitably, the apparatus is adapted to combine and mix enriched air with un-enriched air before supplying enriched air to the engine air inlet manifold.

Suitably, the chamber is adapted such that the liquid is contained in a lower section thereof and the airspace is provided in an upper section thereof.

Suitably, the apparatus comprises a baffle in the chamber between upper and lower sections of the chamber, said baffle having at least one aperture allowing air to pass through the baffle. Suitably, the baffle is inclined across the chamber.

Suitably, the baffle comprises an inclined baffle which divides the chamber. Suitably, at least part of the baffle lies within the chamber air space in use. Suitably, at least part of the baffle is submerged in the liquid in use. Suitably the baffle is adapted to be partially submerged by the liquid. Suitably, the baffle acts to restrict movement of the liquid within the chamber. Suitably, the baffle comprises a solid plate below the liquid surface. Suitably, the baffle comprises one or more apertures above the liquid surface to allow air to pass there through.

Suitably, the apparatus comprises at least one air inlet to deliver air into a lower section of the chamber. Suitably, an air port is provided at the top of the chamber and an inlet tube extends inside the chamber from said port toward the bottom of the chamber with an air inlet being provided at or toward the lower end of the tube.

Suitably, the apparatus comprises an air outlet to withdraw air from an upper section of the chamber for delivery to an engine, suitably for delivery to an engine air intake manifold.

Suitably, in use, said chamber is partly filled with an oil based liquid and pressurised air is conveyed through the air inlet and passed through the oil based liquid to enrich the air and pressurised enriched air passes from the air outlet through the air intake manifold of an engine from where it is mixed with fuel for combustion. Suitably, the baffle prevents oil based liquid from exiting the air outlet.

Suitably, the chamber includes a level indicator. Suitably, the indicator is in the form of a sight glass.

Suitably, flow control means is provided to control flow of air to the air inlet means. Suitably, the flow control means is adapted to control the flow of pressurised air. Suitably, the flow control means comprises a flow regulator, suitably a regulator valve. Suitably, the flow control means comprises an on/off valve. Suitably the flow control means comprises a one way valve.

Suitably, the flow control means upstream of the air inlet may prevent engine run-away and/or may prevent the engine running on additives in the event of backflow.

Suitably, flow control means is provided to control flow of air from the air outlet means. Suitably, a flow regulator, suitably a regulator valve, is provided to control flow of air from the air outlet to the engine, for example to the air inlet manifold.

Suitably a jet is provided downstream of the air outlet means.

Suitably, the apparatus is adapted to enrich air for compression ignition engines. Suitably, the apparatus is adapted to enrich air for diesel engines.

Suitably, a filter is provided to filter air before it enters the inlet means. Suitably, the filter comprises a multi-stage filter. Suitably, the filter is provided upstream of the pressurising means. Suitably, the filter is formed of a knitted copper mesh. Suitably, the filter includes two or more sections each with different mesh sizes.

Suitably, the filter comprises a first filter section comprising copper mesh and a second filter section comprising copper mesh of smaller mesh size than the first. Suitably, the filter comprises a third filter section comprising copper mesh of smaller mesh size than the second.

Suitably, the apparatus comprises a liquid within the chamber. Suitably, the apparatus comprises an oil based liquid, for example a cylinder lubricant.

The apparatus may be fitted to new vehicles or retro-fitted.

The apparatus may comprise any feature as described in relation to the first aspect. The apparatus may be employed in the method of the first aspect.

According to a third aspect of the present invention there is provided an engine air supply assembly, said assembly comprising:

(i) a pressurising means for producing pressurised air; and
(ii) an apparatus for enriching air for an engine;
wherein, said apparatus (ii) is adapted to receive air from the pressurising means (i) and wherein said apparatus (ii) comprises:
(a) a chamber adapted to contain a liquid and to comprise an air space above said liquid;
(b) air inlet means adapted to convey air into the chamber such that it passes through said liquid;
(c) air outlet means adapted to convey enriched air from the chamber for supply to an engine; and
(d) baffle means adapted to restrict the egress of liquid from the chamber via the air outlet whilst allowing the passage of enriched air.

Suitably, said apparatus (ii) is adapted to receive pressurised air from the pressurising means (i).

Suitably, the inlet means is adapted to convey pressurised air into the chamber such that it passes through said liquid.

Suitably, the air outlet means (c) is adapted to convey pressurised enriched air from the chamber for supply to an engine.

Suitably, the baffle means (d) is adapted to restrict the egress of liquid from the chamber via the air outlet whilst allowing the passage of pressurised enriched air.

The assembly may comprise any feature as described in relation to the second aspect. Suitably, the apparatus (ii) comprises an apparatus according to the second aspect.

Suitably, the pressurising means (i) is adapted to pressurise ambient air. Suitably, the pressurising means comprises pressurising means such as a compressor, turbocharger or supercharger of an engine.

Suitably, the pressurising means (i) comprises a turbocharger. Suitably, the turbocharger is arranged to produce a first air stream which is conveyed to the apparatus (ii) and a second air stream which is supplied to an engine. Suitably, the second air stream has at least double the mass flow rate of the first air stream, and may have a mass flow rate which is five or ten times higher. Suitably, the turbocharger has a wastegate valve. Suitably, the wastegate valve is in communication with the first air stream.

Suitably, the assembly further comprises filter means. Suitably, the filter means is provided upstream of the apparatus (ii). Suitably, the filter means is provided upstream of the pressurising means (i).

Suitably, the filter means comprises a multi-stage filter. Suitably, the filter is formed of a knitted copper mesh. Suitably, the filter includes two or more sections each with different mesh sizes.

Suitably, the filter comprises a first filter section comprising copper mesh and a second filter section comprising copper mesh of smaller mesh size than the first. Suitably, the filter comprises a third filter section comprising copper mesh of smaller mesh size than the second.

Suitably, the assembly is adapted such that a first air stream is conveyed from the pressurising means (i) to said chamber of the apparatus (ii) and a second air stream is conveyed to an engine, suitably to an air inlet manifold of an engine. Suitably, air which has passed through the chamber is combined with said second air stream and/or reintroduced to the pressurising means (i).

Suitably, the assembly is adapted such that the air stream which exits the chamber of the apparatus (ii) is returned to a pressurising means (i). The majority of the pressurised enriched air may then be supplied to an engine whilst a portion may be re-circulated to the chamber of the apparatus (ii). Alternatively, or in addition, the air stream which exits the chamber of the apparatus (ii) may be combined with an air stream for supply to an engine at a point downstream of the pressurising means (i).

Suitably, the assembly further comprises flow control means to control the flow of air to and from the apparatus (ii).

The assembly may further comprise an intercooler.

Suitably, the assembly comprises means for adapting the operation of an engine. Suitably, the assembly comprises means for adapting the operation of an engine to take into account the supply of enriched air thereto.

The assembly may comprise engine control electronics. Suitably, the assembly comprises a control circuit for adapting the operation of an engine. Suitably, the assembly comprises control means for adapting the fuel supply to an engine so that reduced fuel is supplied to the engine.

Suitably, the assembly is adapted to reduce the quantity of fuel supplied to the engine when the engine is supplied with enriched air compared to the quantity of fuel that would be supplied to the engine if supplied with un-enriched air. The assembly may be adapted to take into account the supply of enriched air to the engine by reducing the quantity of fuel supplied to the engine.

Suitably, the assembly is adapted to monitor the amount of air being supplied to an engine and adjust the fuel supply to the engine relative to the air supply. Suitably, the assembly is adapted to monitor the amount of air passing through the engine air inlet manifold. Suitably, the assembly comprises an airflow sensor, suitably located in the engine air inlet manifiold.

Suitably, the assembly is adapted to monitor the airflow through the engine air inlet manifold and to control the supply of fuel to the engine in response thereto. Suitably, the assembly is adapted to monitor the airflow using a sensor and modify the fuel supply to compensate for the fact the air is enriched.

The assembly may comprise an airflow sensor designed to operate with un-enriched air and the output and/or response thereto may be modified such that fuel is supplied to the engine at an appropriate rate to accommodate the fact the air is enriched.

The assembly may comprise any feature as described in relation to the first aspect. The assembly may be employed in the method of the first aspect.

According to a fourth aspect of the present invention there is provided a vehicle using a method of enriching an air supply for an engine according to the first aspect and/or comprising an apparatus for enriching an air supply for an engine according to the second aspect and/or comprising an engine air supply assembly according to the third aspect.

Suitably, the vehicle comprises an automobile, for example a car, van, lorry or truck.

Suitably, the vehicle comprises a vehicle having a compression ignition engine. Suitably, the vehicle comprises a vehicle having a diesel engine.

### BRIEF DESCRIPTION OF DRAWINGS

The invention will now be illustrated by way of example with reference to the accompanying drawings in which:

FIG. 1 is cross section of an engine air supply assembly incorporating an apparatus for enriching an air supply for an engine;

FIG. 2 is a cross section of a part of an apparatus for enriching an air supply for an engine; and

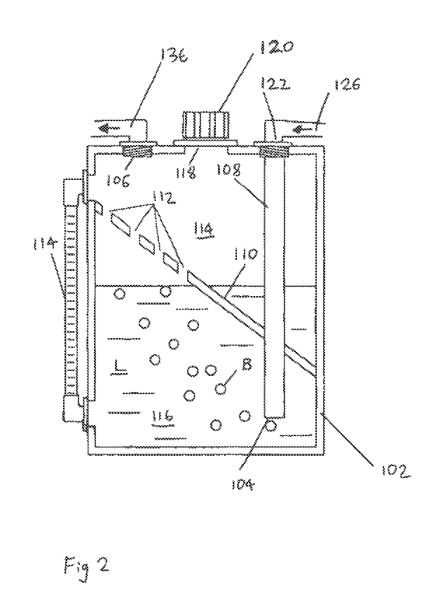

FIG. 3 is perspective view of the apparatus of FIG. 2.

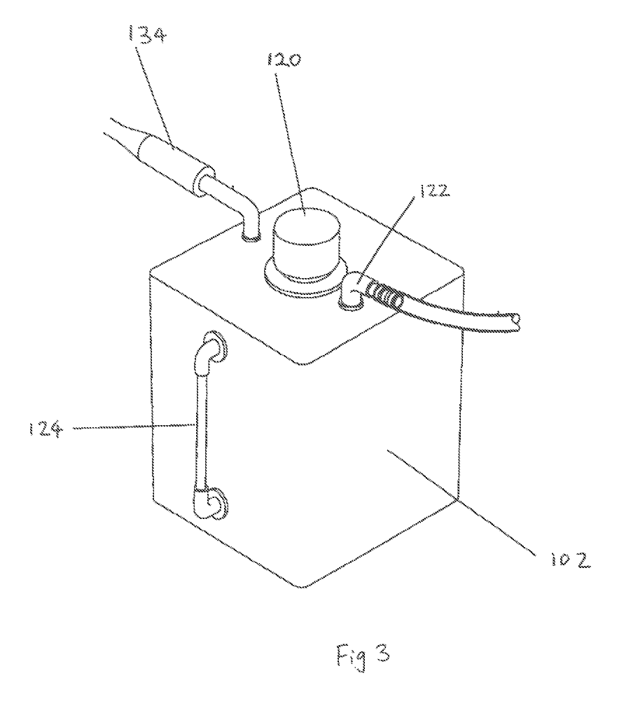

### DETAILED DESCRIPTION OF PREFERRED EMBODIMENTS

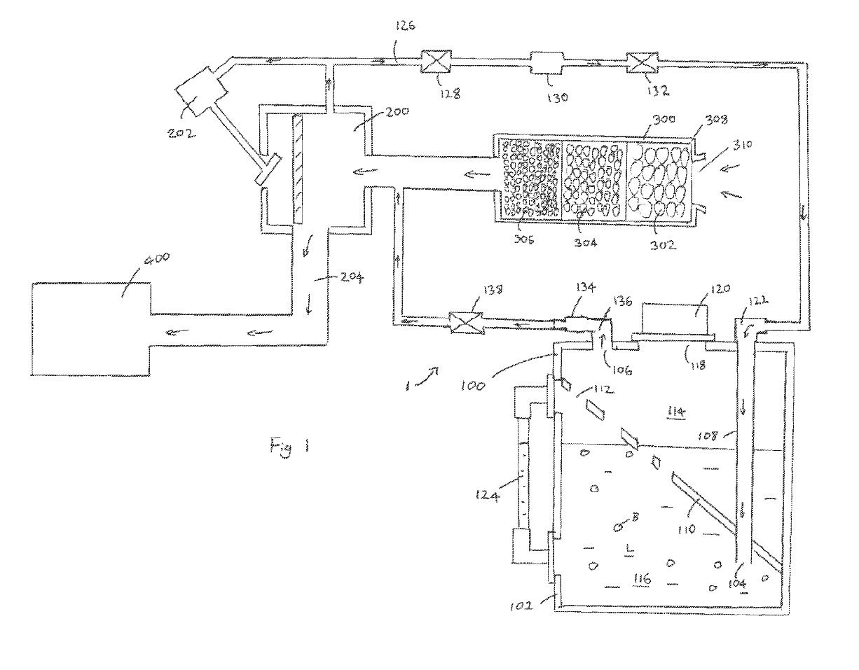

As illustrated by FIG. 1 an engine air supply assembly 1 comprises an apparatus 100 for enriching an air supply for an engine (not shown) and a pressurising means for producing pressurised air in the form of a turbocharger 200 as well a filter 300. These operate together to supply air to an engine air intake manifold 400.

The apparatus 100 for enriching an air supply for an engine (not shown) comprises a chamber 102 adapted to contain a liquid, namely an oil based liquid. The apparatus further comprises an air inlet 104 through which pressurised air is conveyed into the chamber and an air outlet 106 through which pressurised and enriched air is conveyed from the chamber for supply to an engine (not shown).

The apparatus 100 comprises an air inlet tube 108 having the inlet 104 at the lower end thereof. Although only one inlet and tube is shown in the illustrated embodiment other embodiments (not shown) comprise two or more to help improve the enrichment process.

The apparatus 100 further comprises a baffle 110. The baffle 110 is inclined and comprises apertures 112 in the upper part thereof. Said apertures 112 are configured to allow air to pass through the baffle 110. The baffle 110 is adapted to restrict liquid from slopping around the chamber and from exiting the chamber via air outlet 106 whilst apertures 112 therein allow enriched air to pass through the baffle 110.

The chamber 102 is adapted such that it comprises an upper section 114 and a lower section 116 with the lower section 116 arranged to accommodate an oil based liquid L and with the upper section 114 arranged to provide an airspace.

The chamber 102 further comprises a filler aperture 118 covered by a filler cap 120. The chamber may be supplied with an oil based liquid L via said filler aperture 114. The chamber 102 is provided with a liquid level indicator in the form of a sight glass 124. This allows the level of liquid L in the chamber 102 to be monitored and replenished as required through filler aperture 118.

In use the chamber 102 is part filled with an oil based liquid L which can be a cylinder lubricant. The chamber 100 is part filled with oil based liquid L such that the apertures 112 of the baffle 110 lie above the level of the liquid L and such that the inlet 104 lies below the level of the liquid L.

As noted, the air inlet 104 is provided at the end of an inlet tube 108 and that tube 108 extends from a port 122 at the top of the chamber 102 to the lower section 116 of the chamber 102. In use, pressurised air is thus delivered into the lower portion of liquid L in the lower section 116 of the chamber 102. The port 122 receives pressurised air from a stream 126 drawn off from a turbocharger 200.

Before entering the turbocharger 200 air is drawn through a filter 300. The filter 300 comprises three filter sections 302, 304, 306 located in a filter casing 308 which has a filter inlet 310 from which air is passed to said filter sections. Each filter section 302, 304, 306 comprises a knitted copper mesh. The filter sections 302, 304, 306 each contain copper mesh of a different mesh size with the mesh of filter part 302 the largest size and the mesh of filter part 306 the smallest size. The filter 300 provides filtered air to the turbocharger 200 and thus to the apparatus 100 and also to the engine (not shown).

The turbocharger is of known construction and comprises a wastegate valve 202. The wastegate valve 202 is in fluid communication with the stream 126 drawn off from the turbocharger.

The apparatus 100 further comprises a regulator valve 128, a one way flow valve 130 and an on/off valve 132 located along the pathway of stream 126 so as to control the flow of pressurised air to the chamber 102.

As noted, the apparatus 100 comprises an air outlet 106 which is provided at the top of chamber 102. The apparatus 100 further comprises a jet 134 through which a stream 136 exiting the chamber 102 passes in use. A regulator valve 138 is located in the pathway of stream 136 to regulate the supply of air from the chamber 102 to an engine (not shown).

In the illustrated embodiment the assembly is adapted such that pressurised enriched air is conveyed from the chamber 102 along stream 126 to an engine (not shown) via the turbocharger 200. In use the pressurised enriched air is combined with air drawn in from the filter 300 in the turbocharger and the combined stream 204 is conveyed to the inlet manifold 400 of an engine (not shown). In an alternative embodiment (not shown) stream 126 may be fed directly to an air intake manifold of an engine.

In use, ambient air is drawn into the assembly through filter 300 and enters the turbocharger 200 where it is pressurised. Air then leaves the turbocharger in two air streams. A first air stream is conveyed to the chamber 102 of the apparatus 100 and a second air stream is conveyed to an engine air intake manifold 400. The first air stream 126 passes through a regulator valve 128, a one way valve 130 and an on/off valve 132. The first air stream 126 then passes through air port 122 and through inlet tube 108 to the air inlet 104 where it enters into the oil based liquid L which comprises cylinder lubricant. Air emerges as bubbles B in the liquid which entrain small amounts of evaporated lubricant. The lubricant (additive) enriched air passes through the apertures 112 of the baffle 110 and out through air outlet 106. The enriched air stream 136 which exits the chamber 102 then passes through a jet 134 and a regulator valve 138 before being returned to the turbocharger 200. The enriched air is combined with air in the turbocharger 200 and then the majority of the enriched air is supplied to the engine air intake manifold 400 in air stream 204 with a small amount being re-circulated to the chamber 102 with air stream 126. The enriched air supplied to the air intake manifold 400 is then mixed with fuel for combustion.

It will be appreciated that an apparatus, assembly and/or method according to a preferred embodiment of the invention may lead to improved fuel efficiency and/or reduced emissions due to improved combustion in an engine supplied with enriched air.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of enriching an air supply for an engine, said method comprising conveying pressurised air to a chamber containing a liquid and causing said air to pass through the liquid to enrich the air with one or more additives and then conveying enriched air from the chamber for supply to an engine.

2. A method according to claim 1, wherein the method comprises conveying pressurised air into a chamber containing a liquid and causing said pressurised air to pass through the liquid to enrich the air with one or more additives and then conveying pressurised and enriched air from the chamber for supply to an engine.

3. A method according to claim 1, wherein the engine comprises a compression ignition engine.

4. A method according to claim 1, wherein the engine comprises a diesel engine.

5. A method according to claim 1, wherein the liquid comprises an oil based liquid.

6. A method according to claim 5, wherein the oil-based liquid is an upper cylinder lubricant.

7. A method according to claim 1, wherein the chamber contains a liquid in such a quantity that an air space is provided above the liquid.

8. A method according to claim 1 wherein the method comprises pressurising air using pressurising means which comprises a compressor, turbocharger or supercharger of an engine.

9. A method according to claim 1, wherein the method comprises drawing air into a pressurising means, pressurising said air and conveying a stream of air from the pressurising means to the chamber containing a liquid and wherein a first air stream is conveyed from the pressurising means to said chamber and a second air stream is conveyed to an engine.

10. A method according to claim 1, wherein the method comprises treating air before it is conveyed to the chamber.

11. A method according to claim 1, wherein the method comprises passing the air through a filter comprising copper.

12. A method according to claim 1, wherein the method comprises passing an air stream through one or more valves before it enters the chamber to regulate the supply of air to the chamber.

13. A method according to claim 1, wherein the method comprises introducing pressurised air into the chamber via a submerged air inlet.

14. A method according to claim 1, wherein the method comprises removing enriched air from the chamber via a non-submerged air outlet.

15. A method according to claim 1, wherein the chamber has a lower section which contains a liquid and an upper section which comprises an air space and wherein a baffle means is located within the chamber to restrict the movement of liquid between the upper and lower sections whilst allowing the flow of air there between.

16. A method according to claim 1, wherein the air stream which exits the chamber is returned to a pressuring means and wherein the majority of the enriched air is then supplied to an engine whilst a portion is re-circulated to the chamber.

17. A method according to claim 1, wherein the air stream which exits the chamber is returned to a pressurising means such that it is combined with and mixed with un-enriched air before being supplied to an engine air inlet manifold.

18. A method according to claim 1, wherein the method comprises adapting the operation of an engine to take into account the supply of enriched air thereto.

19. A method according to claim 18, wherein the method comprises reducing the quantity of fuel supplied to the engine when the engine is supplied with enriched air compared to the quantity of fuel that would be supplied to the engine if supplied with un-enriched air.

20. An apparatus for enriching air for an engine, said apparatus comprising:
(a) a chamber adapted to contain a liquid and to comprise an air space above said liquid;
(b) air inlet means adapted to convey pressurised air into the chamber such that it passes through said liquid;
(c) air outlet means adapted to convey enriched air from the chamber for supply to an engine; and
(d) baffle means adapted to restrict the egress of liquid from the chamber via the air outlet whilst allowing the passage of enriched air.

21. An apparatus according to claim 20, wherein the apparatus is adapted to supply enriched air such that it is reintroduced to a pressurising means from which it is supplied to an engine and/or such that it is combined with an air stream from a pressurising means downstream thereof such that the combined air stream is supplied to an engine.

22. An engine air supply assembly, said assembly comprising:
(i) a pressurising means for producing pressurised air; and
(ii) an apparatus for enriching air for an engine;
wherein, said apparatus (ii) is adapted to receive air from the pressurising means (i) and wherein said apparatus (ii) comprises:
(a) a chamber adapted to contain a liquid and to comprise an air space above said liquid;
(b) air inlet means adapted to convey air into the chamber such that it passes through said liquid;
(c) air outlet means adapted to convey enriched air from the chamber for supply to an engine; and
(d) baffle means adapted to restrict the egress of liquid from the chamber via the air outlet whilst allowing the passage of enriched air.

23. An assembly according to claim 22, wherein the assembly is adapted such that a first air stream is conveyed from the pressurising means (i) to said chamber of the apparatus (ii) and a second air stream is conveyed to an engine.

24. An assembly according to claim 23, wherein air which has passed through the chamber is combined with said second air stream and/or reintroduced to the pressurising means (i).

25. An assembly according to claim 22, wherein the pressurising means (i) comprises a turbocharger and wherein the turbocharger is arranged to produce a first air stream which is conveyed to the apparatus (ii) and a second air stream which is supplied to an engine and wherein the second air stream has at least double the mass flow rate of the first air stream.

26. An assembly according to claim 22, wherein the assembly is adapted such that the air stream which exits the chamber of the apparatus (ii) is returned to a pressurising means (i) and wherein the majority of the pressurised enriched air is then supplied to an engine whilst a portion is recirculated to the chamber of the apparatus (ii).

27. An assembly according to claim 22, wherein the assembly comprises means for adapting the operation of an engine to take into account the supply of enriched air thereto.

28. An assembly according to claim 27, wherein the assembly comprises a control circuit for adapting the operation of an engine.

29. An assembly according to claim 22, wherein the assembly further comprises filter means provided upstream of the apparatus (ii).

30. (canceled)

31. (canceled)

32. (canceled)
